(19) United States
(12) Patent Application Publication
(10) Pub. No.: US 2026/0138702 A1
(43) Pub. Date: May 21, 2026

(54) SUSPENSION FORK SEALHEAD FOR INCREASED COMPONENT LUBRICATION

(71) Applicant: Fox Factory, Inc., Duluth, GA (US)

(72) Inventors: William M. Becker, Aptos, CA (US); Damon Gilbert, Aptos, CA (US)

(21) Appl. No.: 19/344,646

(22) Filed: Sep. 30, 2025

Related U.S. Application Data
(60) Provisional application No. 63/720,875, filed on Nov. 15, 2024.

(51) Int. Cl. B62K 25/08

(52) U.S. Cl. CPC B62K 25/08; B62K 2201/08

(57) ABSTRACT

The present disclosure provides a suspension fork comprising a fork leg comprising an upper tube and a lower tube slidably engaged with one another for compression and rebound, a damper assembly positioned within the fork leg, the damper assembly comprising a shaft and a sealhead coupled to the shaft, and a reservoir configured to retain bath oil in proximity to the sealhead. The sealhead is sized and positioned to splash bath oil upwards when the sealhead is driven into the bath oil during the compression of the suspension fork. The sealhead comprises a base portion and a leading portion tapering downwards from the neck. The hydrodynamic profile of the sealhead creates controlled oil displacement patterns that distribute lubricating oil to internal components including bushings, seals, and sliding surfaces during suspension movement.

### CROSS-REFERENCE TO RELATED APPLICATION

This application claims the benefit of and priority to U.S. Provisional Ser. No. 63/720,875 filed Nov. 15, 2024, entitled “Inverted Suspension Fork with Improved Air Spring and Lubrication,” the contents of which being incorporated by reference in their entirety herein.

### TECHNICAL FIELD

The present disclosure relates generally to suspension systems for vehicles and, more particularly, to suspension forks and sealheads thereof.

### BACKGROUND

Suspension systems in vehicles, particularly those used in bicycles and motorcycles, rely heavily on proper lubrication to function effectively and maintain longevity. Bath oil plays a critical role in these systems by providing lubrication to various components, including bushings, seals, and sliding surfaces. In suspension forks, the bath oil reduces friction between moving parts, dissipates heat generated during operation, and helps prevent wear and corrosion. Notably, the oil creates a thin film between sliding surfaces, allowing for smooth movement and minimizing metal-to-metal contact.

This lubrication is particularly important in the dynamic environment of a suspension fork, where rapid and repetitive movements occur as the fork compresses and extends. Without adequate lubrication, the suspension components experience increased friction, leading to reduced performance, premature wear, and potential failure. Additionally, the oil contributes to the overall damping characteristics of the suspension, influencing how the fork responds to impacts and vibrations.

### BRIEF SUMMARY

Various embodiments are disclosed for a suspension fork having a sealhead optimized for splashing bath oil to lubricate internal components of a fork leg. According to an aspect of the present disclosure, a suspension fork is provided. The suspension fork comprises a fork leg comprising an upper tube and a lower tube slidably engaged with one another for compression and rebound. The suspension fork comprises a damper assembly positioned within the fork leg, the damper assembly comprising a shaft and a sealhead coupled to the shaft. The suspension fork comprises a reservoir configured to retain bath oil in proximity to the sealhead, wherein the sealhead is sized and positioned to splash the bath oil upwards when the sealhead is driven into the bath oil during the compression of the suspension fork.

The sealhead may comprise a base portion and a leading portion tapering downwards. The sealhead may further comprise a neck having a diameter less than an adjacent portion of the leading portion, wherein the diameter of the neck is less than a diameter of the base portion. The base portion may be configured to form a connection with a cylinder positioned in the fork leg, and the shaft may extend through the cylinder. A bottom surface of the sealhead may be flat.

The sealhead may have a first annular recess having an annular bushing positioned therein, and a second annular recess having an annular seal positioned therein. The fork leg may comprise an upper tube, at least one bushing, and a foam ring, at least one of the upper tube, the at least one bushing, and the foam ring having an amount of the bath oil coated thereon in response to a splashing of the bath oil by the sealhead.

The sealhead may have a base portion, a leading portion, and an intermediary portion positioned between the base portion and the leading portion, the base portion having a diameter greater than the leading portion and the intermediary portion and having edges that taper downwards, the intermediary portion having a uniform outer diameter, and the leading portion tapering downwards from the intermediary portion. The base portion may taper downwards to the neck, and the leading portion may taper downwards from the neck. At least one of the leading portion, the neck (if present), or the base portion may have a concave surface. The suspension fork may further comprise a plurality of machined features positioned in an annular arrangement around a topmost edge of the leading portion.

According to another aspect of the present disclosure, a suspension fork is provided. The suspension fork comprises an upper tube. The suspension fork comprises a lower tube slidably engaged with the upper tube. The suspension fork comprises a damper assembly positioned within at least one of the upper tube or the lower tube, the damper assembly comprising a shaft and a sealhead coupled to the shaft, the sealhead configured to translate relative to the lower tube. The suspension fork comprises a reservoir configured to retain bath oil, wherein the sealhead comprises a base portion and a leading portion tapering downwards from the base portion, wherein the sealhead is configured to splash the bath oil upwards when driven into the bath oil during compression of the suspension fork.

The sealhead may further comprise a neck positioned between the base portion and the leading portion, wherein the neck has a diameter less than an adjacent portion of the leading portion. The base portion may have a U-shaped cross-section and may be configured to form a connection with a cylinder positioned in at least one of the upper tube or the lower tube. The sealhead may comprise a first annular recess having an annular bushing positioned therein, and a second annular recess having an annular seal positioned therein.

The fork leg may comprise an upper tube, at least one bushing, and a foam ring, at least one of the upper tube, the at least one bushing, and the foam ring having an amount of the bath oil coated thereon in response to a splashing of the bath oil by the sealhead. The base portion may taper downwards to the neck. The sealhead may have a base portion, a leading portion, and an intermediary portion positioned between the base portion and the leading portion, the base portion having a diameter greater than the leading portion and the intermediary portion and having edges that taper downwards, the intermediary portion having a uniform outer diameter, and the leading portion tapering downwards from the intermediary portion.

According to another aspect of the present disclosure, a method is provided. The method comprises providing a suspension fork, the suspension fork comprising a fork leg, the fork leg comprising a shaft and a sealhead coupled to the shaft, and a reservoir retaining bath oil in proximity to the sealhead. The method comprises during a compression of the fork leg, causing, by the sealhead, the bath oil to splash upwards to lubricate an upper component of the fork leg. The upper component as lubricated may comprise at least one of: an upper tube of the fork leg; at least one upper bushing; and a foam ring.

This summary is provided to introduce a selection of concepts in a simplified form that are further described below in the detailed description. The summary is not intended to identify key features or essential features of the claimed subject matter, nor is it intended to be used as an aid in determining the scope of the claimed subject matter. The foregoing general description of the illustrative embodiments and the following detailed description thereof are merely exemplary aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a front view of an inverted suspension fork according to various embodiments of the present disclosure.

FIG. 2 is a front view of the inverted suspension fork of FIG. 1 shown in full compression according to various embodiments of the present disclosure.

FIG. 3 is a front view of the inverted suspension fork of FIG. 1 in full rebound according to various embodiments of the present disclosure.

FIG. 4 is a cross-sectional view of the inverted suspension fork of FIG. 1 according to various embodiments of the present disclosure.

FIG. 5 is a cross-sectional view of an upper portion of the suspension fork of FIG. 1 according to various embodiments of the present disclosure.

FIG. 6 is a cross-sectional view of an upper portion of a damper side of the suspension fork of FIG. 5 according to various embodiments of the present disclosure.

FIG. 7 is a cross-sectional view of a lower portion of the damper side of the suspension fork of FIG. 4 showing a profile of a sealhead according to various embodiments of the present disclosure.

FIG. 8 is another profile view of a sealhead according to various embodiments of the present disclosure.

FIG. 9 is yet another profile view of a sealhead according to various embodiments of the present disclosure.

FIGS. 10 and 11 are perspective views of the sealhead of FIGS. 7 and 8 according to various embodiments of the present disclosure.

FIG. 12 is another profile view of a sealhead according to various embodiments of the present disclosure.

FIG. 13 is yet another profile view of a sealhead according to various embodiments of the present disclosure.

FIG. 14 is yet another profile view of a sealhead according to various embodiments of the present disclosure.

### DETAILED DESCRIPTION

The present disclosure relates to a suspension fork having a predetermined profile geometry optimized such that, when the sealhead is driven into an oil bath volume at an internal bottom of the suspension fork, bath oil is caused to splash upwards with a suitable force to lubricate various internal components of the suspension fork.

Inadequate lubrication in suspension forks and other suspension systems may lead to a range of performance issues and potential component failures. When lubrication is insufficient, the moving parts within the suspension system may experience increased friction, which can result in reduced responsiveness, decreased smoothness of operation, and a less comfortable ride for the rider. This lack of proper lubrication may also cause accelerated wear on various components, such as bushings, seals, and sliding surfaces, potentially shortening the overall lifespan of the suspension system.

In some cases, insufficient lubrication in suspension systems may lead to a phenomenon known as “stiction,” where static friction between components momentarily prevents smooth movement at the beginning of the suspension stroke. This can result in a jerky or inconsistent suspension action, particularly noticeable when encountering small bumps or vibrations. Additionally, inadequate lubrication may contribute to increased heat buildup within the suspension system during operation, which can potentially degrade the performance of seals and other components over time. Proper lubrication is therefore crucial for maintaining optimal suspension performance, durability, and rider comfort across various types of terrain and riding conditions.

Accordingly, various embodiments of the present disclosure relates to a suspension fork with a sealhead designed to optimize lubrication of internal components. The suspension fork includes a fork leg comprising an upper tube and a lower tube slidably engaged with one another for compression and rebound. A damper assembly is positioned within the fork leg and includes a shaft with a sealhead coupled to it. The suspension fork also features a reservoir configured to retain bath oil in proximity to the sealhead. The sealhead is sized and positioned to splash or otherwise force the bath oil upwards when driven into the bath oil during movement (e.g., compression) of the suspension fork.

In some embodiments, the sealhead may have a profile comprising a base portion, a neck, and a leading portion tapering downwards from the neck. The neck may have a diameter less than an adjacent portion of the leading portion. The sealhead may also have a U-shaped cross-section in the base portion, a flat bottom surface, and annular recesses for bushings and seals. The geometry of the sealhead can contribute to the splashing effect. These components may work together to enhance the ability of the sealhead to distribute lubricating oil effectively throughout the suspension system.

The suspension fork design may be applied to various configurations, including single-leg systems and dual-leg suspension systems on bicycles, motorbikes, electric bicycles, and so on. In a dual-leg system, one leg may house the damper assembly with the specialized sealhead, while the other leg may contain an air spring assembly. This arrangement allows for optimized performance and lubrication in both legs of the suspension system. The profile of the sealhead may contribute to improved overall suspension performance, durability, and rider comfort across different riding conditions and terrain types.

Prior suspension fork designs have incorporated various methods for routing and distributing bath oil to lubricate internal components. Some approaches may include oil channels, ports, or reservoirs strategically placed within the fork structure. However, these designs often rely on passive oil distribution or minimal oil movement during fork operation. While such systems may provide adequate lubrication in some cases, they may not fully optimize the distribution of oil to all critical components, especially during dynamic riding conditions. In contrast, the sealhead described in the present disclosure may take a more active approach to oil distribution. By specifically shaping and positioning the sealhead to splash bath oil upwards during compression, more thorough and consistent lubrication of internal components can be achieved as compared to traditional fork designs.

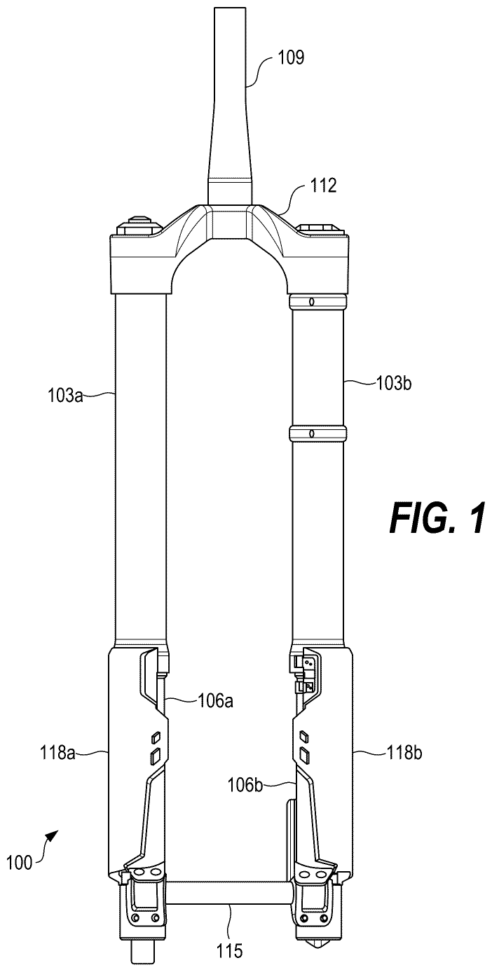

Turning now to the figures, FIGS. 1, 2, and 3 show front views of a suspension system according to various embodiments. The suspension system includes a suspension fork 100. While an inverted-type of suspension fork, referred to as an inverted suspension fork, is shown in various figures, it is understood that the components and functions described herein can also be implemented with other types of suspension forks (e.g., non-inverted suspension forks) and suspension systems without deviating from the principles of the disclosure. Moreover, while a suspension fork 100 is shown having two legs, the principles described herein can be implemented in suspension systems having a single leg, as can be appreciated.

Referring among FIGS. 1-3, the suspension fork 100 includes upper tubes 103a, 103b (collectively “upper tubes 103”) and lower tubes 106a, 106b (collectively “lower tubes 106”). A first lower tube 106a is slidably engaged with a first upper tube 103a, and a second lower tube 106b is slidably engaged with a second upper tube 103b. The slidable engagement can include a telescoping arrangement between the tubes 103, 106. To this end, in some aspects, the upper tubes 103 can have a diameter larger than a diameter of the lower tubes 106. In non-inverted forks, the lower tubes 106 can have a diameter larger than a diameter of the upper tubes 103, however.

The slidable engagement between the upper tubes 103 and lower tubes 106 allows for compression and rebound (or extension) of the suspension fork 100 as an operator (e.g., a rider) traverses various terrain on a bicycle or similar vehicle. When the rider encounters bumps, obstacles, or uneven surfaces, the lower tubes 106 telescopes into the upper tubes 103, absorbing shock and vibration, or vice versa. This movement helps to maintain tire contact with the ground, thereby improving traction and control. As the suspension fork 100 rebounds after compression, the lower tubes 106 extend back out from the upper tubes 103, preparing the suspension for the next impact. The sliding action between the upper tubes 103 and the lower tubes 106 may be facilitated by bushings, seals, and lubricating oil (among other components), which work together to reduce friction and ensure consistent performance throughout the travel range of the suspension fork 100.

The suspension fork 100 further includes a steerer tube 109, a crown 112, and a through-axle 115. The crown 112 may couple the upper tubes 103 to one another, and the through-axle 115 may couple the lower tubes 106 to one another. As such an upper end of each of the upper tubes 103 may couple to the crown 112. The steerer tube 109 and the crown 112 can collectively form a crown-steerer assembly, and the steerer tube 109 can extend vertically from a central portion of the crown 112.

The upper tubes 103 can be assembled by press-fit or pinch-bolts to the crown-steerer assembly. The suspension fork 100 can be fastened to the headtube of a bicycle, motorcycle, or other two-or three-wheeled vehicle through a set of headset bearings internal to the steerer tube 109 and steered by a bolt-on stem-handlebar assembly. This configuration can provide a secure connection between the suspension fork 100 and a frame of a vehicle while allowing for smooth steering control.

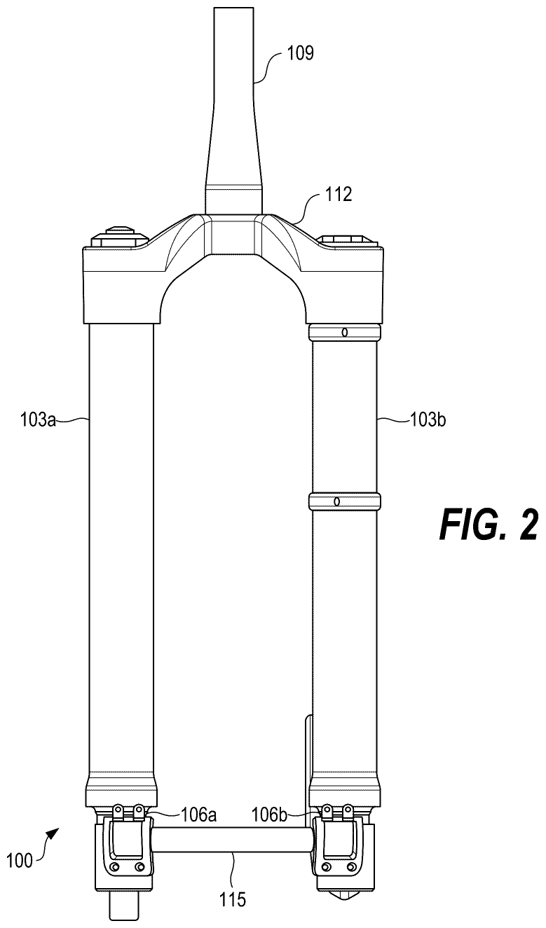

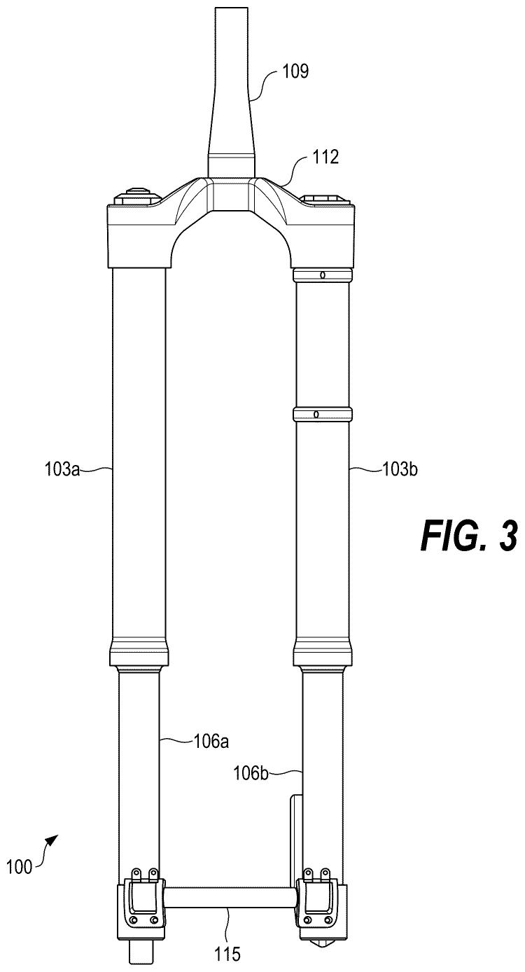

The through-axle 115 can be used to secure the suspension fork 100 to a vehicle. For example, the through-axle 115 can be passed through a hub of a wheel of a vehicle including, but not limited to, a front wheel of a bicycle or motorcycle. In FIG. 1, the suspension fork 100 includes lower guards 118a, 118b (collectively “lower guards 118”) that cover the lower tubes 106, protecting the lower tubes 106 from debris, impact, and other degrading forces. The lower guards 118 are omitted from view in FIGS. 2 and 3 for explanatory purposes, however. The lower guards 118 can be detachably attachable to the suspension fork 100 in some embodiments, or can be integral with the upper tubes 103.

The upper tubes 103, lower tubes 106, and steerer tube 109 can each be constructed from a variety of materials selected to provide an optimal balance of strength, weight, and performance characteristics. In some implementations, these components, among other components of the suspension fork 100, can be fabricated from high-strength aluminum alloys, which offer excellent stiffness-to-weight ratios and corrosion resistance.

Carbon fiber composites can also be utilized, particularly for the steerer tube 109 and upper tubes 103, to further reduce weight while maintaining structural integrity. In other cases, the lower tubes 106 can be constructed from steel alloys to enhance durability and withstand the stresses of repeated compression and extension cycles. Titanium alloys may be employed in premium fork designs, offering a combination of low weight, high strength, and vibration damping. The choice of materials for each component can be selected to meet specific performance requirements, rider preferences, and intended use cases of the suspension fork 100.

FIG. 2 shows the suspension fork 100 in full compression representing the maximum travel of the suspension fork 100, where the lower tubes 106 have telescoped fully into the upper tubes 103. During full compression, a sealhead (not shown) positioned in a damper-side of the suspension fork 100, as will be described, may be at its lowest position, or most proximal to a bottom of the suspension fork 100 where bath oil is stored.

FIG. 2 illustrates an extreme end of the travel range of the suspension fork 100, which typically occurs during significant impacts or landings from large drops. FIG. 3, on the other hand, shows the suspension fork 100 in full extension or rebound. In this position, the lower tubes 106 are extended to their maximum length from the upper tubes 103, representing an opposite end of the travel range from the full compression shown in FIG. 2. This often occurs when the vehicle is unloaded or not in use, or when the suspension is rebounding after absorbing an impact. The full extension position shown in FIG. 3 and the full compression position shown in FIG. 2 collectively illustrate a maximum available travel of the suspension fork 100.

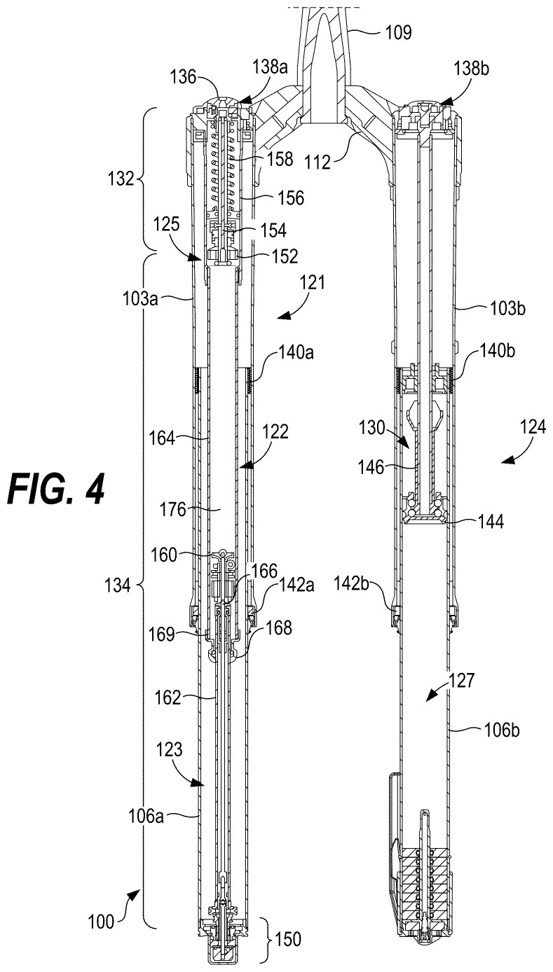

Turning now to FIG. 4, FIG. 4 shows a cross-sectional view of the suspension fork 100 depicting various internal components. The suspension fork 100 can include a damper leg 121 comprising the first upper tube 103a, the first lower tube 106a, and a damper assembly 122 positioned within the damper leg 121. and the suspension fork 100 can further include an air-spring leg 124 comprising the second upper tube 103b and/or the second lower tube 106b. The damper leg 121 can also be referred to as a “damper side” of the suspension fork 100, and the air-spring leg 124 can also be referred to as an “air-spring side” of the suspension fork 100.

The configuration of the suspension fork 100 shown in FIG. 4 illustrates a dual-chamber damper and air-spring assembly that can be provided in high-performance inverted suspension forks 100. The damper leg 121 can include the damper assembly 122 to control a rate of compression and/or rebound of the suspension fork 100, and provide adjustable damping characteristics to suit various riding conditions and preferences. The damper assembly 122 can include a rebound assembly 123 positioned position in a lower portion of the damper leg 121 and/or a compression assembly 125 positioned in the upper portion of the damper leg 121, each of which being adjustable to control rebound and compression, respectively. The damper leg 121 can further include, for example, an upper piston, a lower piston, and shim stacks, among other components, to create hydraulic resistance.

On the other hand, the air-spring leg 124 is configured to provide a main spring force of the suspension fork 100. The air-spring leg 124 may utilize compressed gas to resist compression and return the suspension fork 100 to its extended position, shown in FIG. 3. To this end, the air-spring leg 124 may include a positive air chamber 127 and a negative air chamber 130 positioned within inner walls of a cylinder defined by the upper tube 103b and/or the lower tube 106b. The positive air chamber 127 and the negative air chamber 130 can be adjusted to fine-tune behavior of the suspension fork 100 throughout its travel range. By positioning these assemblies in separate legs of the fork, the design allows for optimal performance of each system without interference, while also distributing the functional components evenly across the suspension fork 100.

The damper assembly 122 may include a compression region 132 inclusive of the compression assembly 125 and a rebound region 134 inclusive of the rebound assembly 123. A compression adjuster 136 can be positioned on the damper leg 121 to control compression in the compression region 132. For instance, the compression adjuster 136 can be positioned on the crown 112 above the first upper tube 103a, can be used to adjust or control desired characteristics of the damper leg 121 and/or the compression region 132 thereof. The compression adjuster 136 can integrate with or be part of one or more topcap assemblies 138a, 138b (collectively “topcap assemblies 138”). The topcap assemblies 138 can be removed from the compression adjuster 136 using a suitable tool, such as an Allen wrench or like tool.

The compression adjuster 136 can provide an interface for riders or vehicle operators to fine-tune the suspension characteristics of the suspension fork 100 or, more specifically, the damper leg 121 thereof. In some implementations, each compression adjuster 136 can include a rotatable dial or knob that a rider or other operator can manipulate to adjust various suspension parameters. By rotating the dial clockwise or counterclockwise, the operator can increase or decrease compression damping, respectively.

The operator may adjust the compression damping using the compression adjuster 136 to control how quickly the suspension fork 100 compresses under load. A firmer setting achieved by rotating the dial clockwise, for example, may provide more resistance to compression, which can be beneficial for smoother terrain or when the rider desires a more responsive feel. Conversely, a softer setting achieved by rotating the dial counterclockwise, for example, may allow for easier compression, improving small bump sensitivity and traction on rough terrain.

In some embodiments, the compression adjuster 136 includes detents or click positions, providing tactile feedback to the operator and allowing for more precise and repeatable adjustments. Additionally, the compression adjuster 136 may include visual indicators, such as numbered markings or color-coded zones, which may help riders track and replicate their preferred settings across different riding conditions.

The damper leg 121 and/or the air-spring leg 124 can include various bushings, such as upper bushings 140a, 140b (collectively “upper bushings 140”), lower bushings 142a, 142b (collectively “lower bushings 142”), and so forth. The upper bushings 140 can be positioned near a top of the lower tubes 106, while the lower bushings 142 can be positioned near the bottom of the upper tubes 103. Together, these bushings 140, 142 guide the sliding motion between the upper tubes 103 and the lower tubes 106, reducing friction and ensuring proper alignment throughout the travel range of the suspension fork 100.

The bushings 140, 142 can be made from low-friction materials such as polytetrafluoroethylene (PTFE) or other specialized polymers designed to withstand the dynamic loads and environmental conditions experienced by the suspension fork 100. The bushings 140, 142 can distribute forces evenly across the sliding surfaces, preventing metal-to-metal contact between the upper tubes 103 and the lower tubes 106, which can reduce wear and extends the life of the suspension fork 100 while also contributing to a smooth and more responsive suspension action.

The air-spring leg 124 can include an air piston 144 coupled to an air shaft 146 which can permit transfer of air pressure between the positive air chamber 127 and the negative air chamber 130. The air shaft 146 can be hollow in some implementations, or might not be hollow in others. The air piston 144 can translate or otherwise move within the cylinder in response to compression and extension of the suspension fork 100. In some implementations, the air shaft 146 can extend from the air piston 144 towards the upper portion of the suspension fork 100, passing through the negative air chamber 130. This can facilitate air transfer between chambers during fork travel, providing spring-like characteristics. The air piston 144 and the air shaft 146 can include seals to maintain proper air pressure separation between chambers and prevent unwanted air loss.

Referring now to the damper leg 121, as previously indicated, the damper leg 121 can include a compression region 132 and/or a rebound region 134 according to various embodiments. The compression region 132 may include a compression assembly 125 that may work in conjunction with the compression adjuster 136 to regulate the rate at which the suspension fork 100 compresses under load, allowing riders to fine-tune the response of the suspension fork 100 to impacts and terrain variations based on their preferences and riding conditions. Similarly, the rebound region 134 may include a rebound assembly 123 that controls a rate at which the suspension fork 100 extends after compression. The rebound assembly can be adjusted using a rebound adjuster and cap assembly 150 positioned on the bottom of the leg of the suspension fork 100, allowing riders to fine-tune the return speed of the suspension fork 100 to suit various riding conditions and personal preferences.

Referring initially to the compression region 132, the compression region 132 may generally include a compression piston 152 coupled to a compression piston shaft 154, among other components. The compression piston 152 translates vertically in the upper tube 103 via the compression piston shaft 154. As such, the compression piston 152 may be configured to move within a damper tube 156, creating resistance to compression of the suspension fork 100. A spring 158 may be positioned around the compression piston shaft 154, providing additional control over the compression and rebound characteristics in the compression region 132. The compression piston shaft 154 may extend through the damper leg 121 and translate therein.

Referring now to the rebound region 134, the rebound region 134 can similarly include a rebound piston 160 coupled to a rebound damper shaft 162, among other components. The rebound damper shaft 162 can be part of a rod assembly in some scenarios. Further, the rebound assembly 123 can include a cylinder 164, where the rebound piston 160 translates within the cylinder 164 to control rebound of the suspension fork 100. The rebound damper shaft 162 can include a needle portion 166 in some embodiments.

A sealhead 168 can be positioned in the damper leg 121 along the rebound damper shaft 162, and can act as a seal, thereby sealing the cylinder 164. As such, the sealhead 168 can form a connection with a bottom end of the cylinder 164, for instance, to prevent fluid (e.g., oil) from leaking out. In some embodiments, the sealhead 168 includes a base having a U-shaped cross-section with threads 169 on the bottom end of the cylinder 164. It is understood, however, that the sealhead 168 can form other types of connections with the cylinder 164, such as an interference connection, a friction connection, and so on.

In some implementations, the rebound damper shaft 162 and the rebound piston 160 attached thereto may remain fixed to the lower tube 106a during compression and rebound. For instance, during compression of the suspension fork 100, the lower tube 106a may telescope into the upper tube 103a, which may cause the rebound piston 160 to move upwards into the upper tube 103a in the view of FIG. 4. In full compression, the rebound piston 160 is positioned relatively close to the compression region 132 (and the compression piston 152 thereof).

Conversely, during rebound, the lower tube 106a may extend or telescope out from the upper tube 103a, and the cylinder 164 may move downwards relative to the rebound piston 160, and towards the position shown in FIG. 4 where the suspension fork 100 is in full extension or rebound. The sealhead 168, being connected to the bottom end of the cylinder 164, may move in conjunction with the cylinder 164 during both compression and rebound cycles. This arrangement may allow for the damping characteristics to be controlled by the relative motion between the rebound piston 160 and the moving cylinder 164, with the sealhead 168 maintaining a fluid seal throughout range of motion.

Generally, a sealhead 168 merely seals a bottom end of the cylinder 164. However, according to various embodiments of the present disclosure, the sealhead 168 can have a particular geometry to optimize and increase a splashing of the bath oil such that the internal components of the suspension fork 100 stay lubricated, as will be described. Moreover, the sealhead 168 is sized and positioned to provide a fluid flow path for the bath oil when contacted by the sealhead 168 or during other oil distribution events.

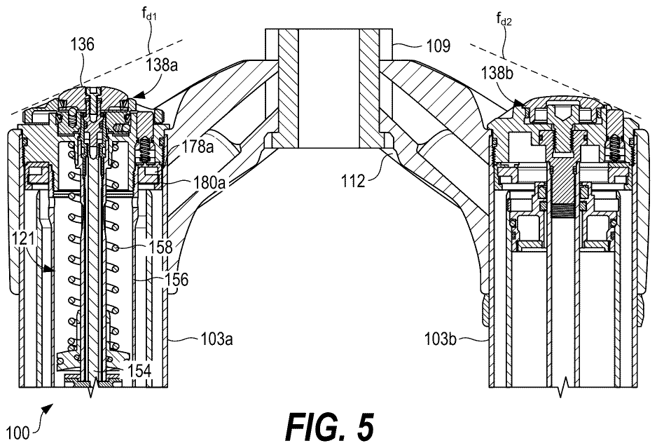

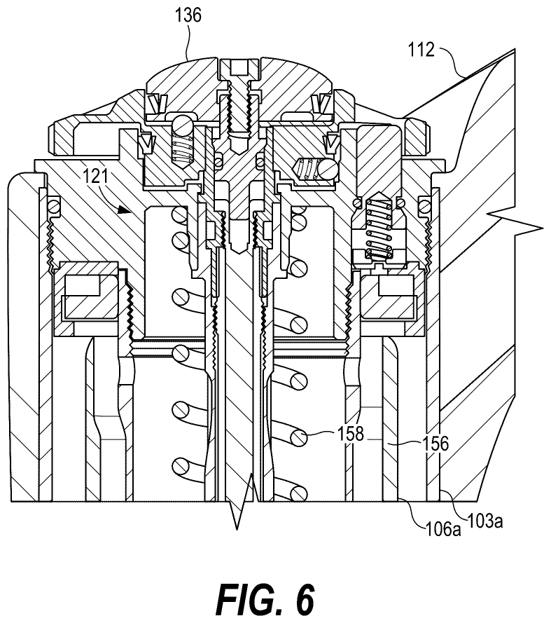

Turning next to FIGS. 5 and 6, FIG. 5 shows a cross-sectional view of an upper portion of the suspension fork 100 of FIG. 4, and FIG. 6 shows an upper cross-sectional view of an upper portion of the damper leg 121 the suspension fork 100. First, with reference to FIG. 5, angles, referred to as frame downtube angles or frame downtubes f_{d1} and f_{d2}, are shown on both sides of the suspension fork 100. The suspension fork 100 can be sized and positioned to provide adequate clearance between the compression adjuster 136, topcap assemblies 138, air bleed valve assemblies, etc., and the frame downtubes f_{d1} f_{d2} when the fork is turned 90 degrees, for example. This clearance can assist in preventing interference or contact between these components during steering maneuvers, particularly in tight turning situations.

The suspension fork 100 can include one or more topcap assemblies 138, such as a first topcap assembly 138a and a second topcap assembly 138b. Referring to FIGS. 5 and 6 collectively, the first topcap assembly 138a is shown as being positioned in or on a first upper tube 103a, and the second topcap assembly 138b is shown as being positioned in or on a second upper tube 103b. The topcap assembly 138 can be threadably attached to the upper tube 106 or other portion of the suspension fork 100. Thus, the topcap assembly 138 can be removed using a screwdriver, Allen wrench, or like tube.

It is understood, however, that other types of connections can be employed to couple the topcap assembly 138 to the tubes of the suspension fork 100, such as a snap-on connection, interference connection, and so forth. In some embodiments, a first portion of the topcap assembly 138 is positioned external the upper tube 103 (e.g., on a top surface of the upper tube 103), whereas a second portion of the topcap assembly 138 is nested or positioned internal the upper tube 103.

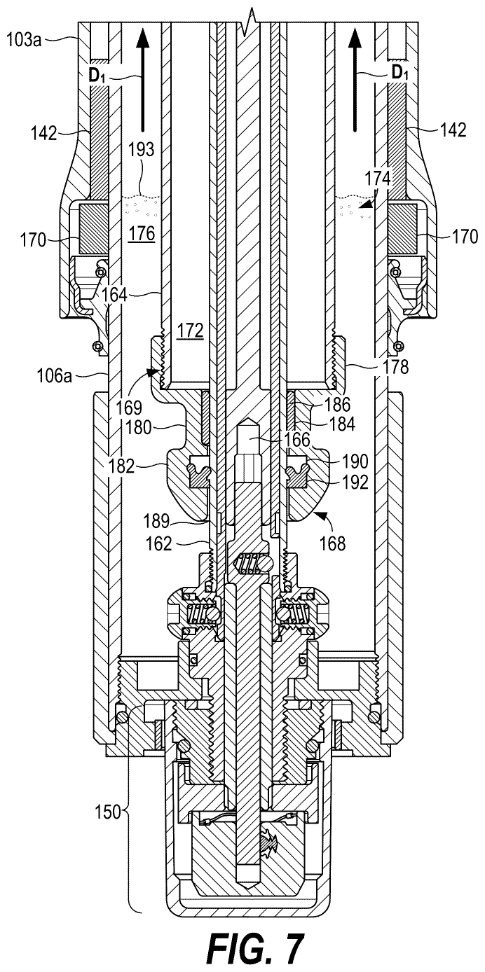

Moving along to FIG. 7, an enlarged portion of a lower end of the damper leg 121 of the suspension fork 100 is shown according to various embodiments. Notably, in the view of FIG. 7, the upper tube 103a and the lower tube 106a are shown in full compression, also referred to as a bottom-out event. As the damper leg 121 is compressed, and as the lower tube 106a telescope into the upper tube 103a, the sealhead 168 approaches a lower end of the damper leg 121, as shown in FIG. 7, during or close to a bottom out event.

On the damper side of the suspension fork 100, it can be desirable to configure the sealhead 168 to splash oil from an oil bath in an upwards direction D₁ to one or more of the upper bushings 140 (FIG. 4) or the lower bushings 142, as well as a ring 170 such that the components are routinely and adequately lubricated. The ring 170 can include, for example, a foam ring or a ring formed of another material. The foam ring 170, for example, can absorb bath oil, and can thus lubricate an outer surface of the leg tubes as it passed along the foam ring 170 during compression and rebound.

Accordingly, in various embodiments, a sealhead 168 having a predetermined profile is described that, when driven into an oil bath volume at the internal bottom of the suspension fork 100 will cause oil to splash upwards to lubricate various internal components of the suspension fork 100.

FIG. 7 shows a cross-section of the cylinder 164, which may be disposed within the lower tube 106a and/or the upper tube 103a, depending on the compression state of the suspension fork 100. The cylinder 164 can include a reservoir 172 having oil disposed therein, where the sealhead 168 can operate to selectively restrict or fully eliminate leakage of oil within the reservoir 172 out of a bottom-side of the cylinder 164.

The cylinder 164 likewise can be positioned in or around an amount of bath oil 174, which can be retained in a reservoir 176 defined by cylindrical walls of the lower tube 106a. In some embodiments, the sealhead 168 can be detachably attached to a bottom end of the cylinder 164. As such, in some embodiments, the sealhead 168 can form a threaded connection (or other suitable type of connection) with the cylinder 164. The sealhead 168 can move in unison with the cylinder 164 during translation of the lower tube 106a respective of the upper tube 103a.

With reference to the cross-sectional view of the sealhead 168, the profile of the sealhead 168 can be seen in FIG. 7. In some implementations, the sealhead 168 can include a base portion 178, a neck 180, and a leading portion 182. The neck 180 may couple the base portion 178 to the leading portion 182 and, as such, the base portion 178 may couple and be directly adjacent to a first side of the neck 180, whereas the leading portion 182 may couple and be directly adjacent to a second, opposing side of the neck 180. In alternative geometries of the sealhead 168, no neck 180 is provided, as will be discussed.

In the particular arrangement of FIG. 7, the base portion 178 is positioned vertically above the neck 180 and the leading portion 182, and likewise, the leading portion 182 is positioned vertically below the base portion 178. It is understood, however, that this orientation may vary based on the orientation of the suspension fork 100.

The neck 180 may have a diameter less than that of the base portion 178 and/or the leading portion 182. As such, the neck 180 is recessed relative to outer surface of the base portion 178 and/or the leading portion 182. The neck 180 and/or a bottom portion of the base portion 178 can collectively include a recess 184 configured to receive and retain a bushing 186 in some embodiments. The recess 184 can include an annular notch surrounding the shaft 162, and the bushing 186 can include an annular bushing sized and positioned to nest within the recess 184 and engage with the shaft 162. The diameter of each of the base portion 178, the neck 180, and the leading portion 182 can be less than an internal diameter of the lower tube 106a. By virtue of this, as well as the geometry of the sealhead 168, a fluid flow path is created that ensures sufficient splashing of the bath oil to facilitate lubrication.

As shown in FIG. 7, a cross-section of the base portion 178 can be U-shaped, such that outer walls overlap a bottom end of the cylinder 164, facilitating a seal between the sealhead 168 and the cylinder 164. The leading portion 182 of the sealhead 168 extends downwards towards a bottom end of the damper leg 121. In some embodiments, and as shown in FIG. 7, the leading portion 182 has a portion adjacent to the neck 180 having a diameter greater than that of the neck 180, and the leading portion 182 extends downwards vertically and then tapers downwards from the vertical extension. A bottom end or bottom surface 189 of the sealhead 168 can be generally flat and/or uniform, which may facilitate splashing.

In some embodiments, the sealhead 168 can further include another recess 190, which can be situated in the leading portion 182 in some embodiments. The recess 190 can include an annular recess configured to receive and retain a seal 192, such as an annular-shaped gasket or other type of seal. As such, the seal 192 can engage with the shaft 162 while being positioned within the sealhead 168.

In some implementations, a level 193 of the bath oil 174 in the reservoir 176 may be configured to rise above the sealhead 168 during or near full compression of the suspension fork 100. In any event, as the lower tube 106a telescopes into the upper tube 103a, the volume available for the bath oil 174 in the reservoir 176 may decrease, causing the oil level to rise. This rising oil level may submerge at least a portion of the sealhead 168, including the leading portion 182 and the neck 180. The submersion of the sealhead 168 in the bath oil 174 during compression may enhance the splashing effect, as the sealhead 168 displaces a larger volume of oil when it moves through the elevated oil level. This may contribute to more effective distribution of the bath oil 174 to upper components of the suspension fork 100, ensuring thorough lubrication of bushings, seals, and other components even during extreme compression events.

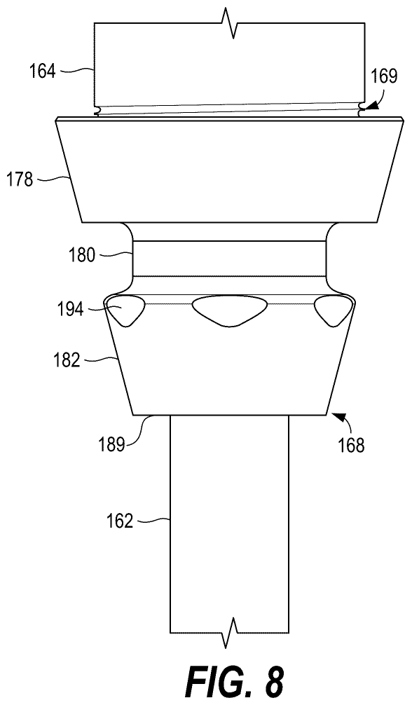

Referring to FIG. 8, an alternative embodiment of the sealhead 168 is shown. As previously described, the sealhead 168 can include a base portion 178, a neck 180, and a leading portion 182, each having distinct geometries that may enhance the oil splashing and sealing capabilities of the sealhead 168. In the embodiment shown in FIG. 8, the base portion 178 of the sealhead 168 may include a linear outer surface that tapers downwards from the cylinder 164 to the neck 180. This tapered design may create a transition between the cylinder 164 and the neck 180, reducing turbulence in oil flow during compression and rebound cycles while providing a fluid flow path. Despite the taper, the base portion 178 may maintain a diameter greater than that of the neck 180 throughout its length, which can provide structural integrity and ensure a secure connection with the cylinder 164.

The neck 180 can serve as a transitional region between the base portion 178 and the leading portion 182. As such, the neck 180 may have a reduced diameter compared to both adjacent portions, which may create recessed areas that could affect oil flow dynamics and the fluid flow path during compression and rebound movements of the suspension fork 100.

The leading portion 182 may include a linear taper, narrowing downwards from the neck 180 towards the shaft 162. This gradual reduction in diameter may help guide oil flow and contribute to the splashing effect as the sealhead 168 moves through the bath oil. The leading portion 182 may maintain a diameter greater than both the neck 180 and the shaft 162 throughout its length. This configuration creates a stepped profile that influences oil displacement and distribution patterns within the suspension fork 100.

The linear tapers of both the base portion 178 and the leading portion 182, along with a bottom surface 189 being relatively flat or planar, work in concert to optimize oil movement and splashing characteristics. As the sealhead 168 moves through the bath oil, these surfaces may cause splashing and help direct oil flow in desired patterns, improving lubrication of internal components in the suspension fork 100. In some embodiments, the transition points between the base portion 178, neck 180, and leading portion 182 may be rounded or chamfered to further refine oil flow characteristics and reduce potential stress concentrations in the sealhead 168 structure.

This alternative sealhead 168 design may offer different performance characteristics compared to other configurations, allowing for fine-tuning of oil distribution and damping properties in the suspension fork 100. The specific angles of the tapers and the relative diameters of each portion may be adjusted to achieve desired performance characteristics for different riding conditions or configurations of the suspension fork 100.

In some embodiments, the leading portion 182 of the sealhead 168 may include machined features 194 positioned in an annular arrangement around an outer surface of the sealhead 168, optionally in a location proximate to the neck 180, such as a topmost edge of the leading portion 182. The machined features 194 may include slight recesses in the surface of the leading portion 182. In this example, the machined features 194 act as wrench flats, providing a flat surface for a wrench, socket, or like tool to form a grip or other connection with an outer surface of the sealhead 168 to tighten or loosen the sealhead 168 onto or from the cylinder 169 or other component.

In some embodiments, the machined features 194 may provide fluid directing characteristics to the sealhead 168. For instance, as the sealhead 168 moves through the bath oil during compression and rebound cycles, the machined features 194 may interact with the oil flow, creating localized turbulence or directing oil in specific patterns. In some embodiments, the size, shape, and arrangement of the machined features 194 may be varied to achieve different fluid flow characteristics, allowing for further customization of the performance of the sealhead 168 in various riding conditions.

For example, in some embodiments, the sealhead 168 may include spiral patterns (not shown) formed on its outer surface, which can create helical fluid flow paths that enhance oil distribution during compression and rebound cycles. The spiral patterns may be machined or otherwise formed into the surface of the leading portion 182, neck 180, or base portion 178 to create controlled turbulence and directional flow of the bath oil 174. Furthermore, the sealhead 168 may incorporate apertures or holes that extend through the body of the sealhead 168, allowing fluid to be directed through internal passages within the sealhead 168. The apertures may be strategically positioned to facilitate oil flow from one side of the sealhead 168 to another, creating additional pathways for lubrication distribution.

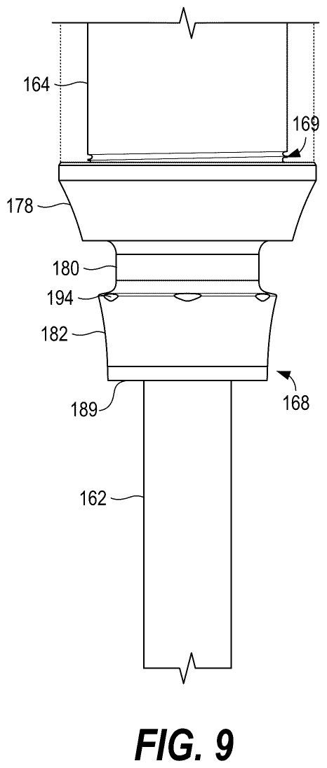

Referring to FIG. 9, another alternative embodiment of the sealhead 168 is shown. The embodiment of FIG. 9 shares similarities with the embodiment of FIG. 8, but includes distinct geometric features that may enhance oil splashing and sealing capabilities.

As shown in FIG. 9, the base portion 178 of the sealhead 168 includes a concave outer surface that tapers downwards from the cylinder 164 to the neck 180. The neck 180 likewise can include a concave surface. The concave taper in the base portion 178 may define a transition between the cylinder 164 and the neck 180. The leading portion 182 in FIG. 9 also includes a tapered, concave outer surface, narrowing downwards from the neck 180 towards the shaft 162. This taper may be more pronounced compared to the embodiment shown in FIG. 8, potentially enhancing the guiding of oil flow and contributing to a more focused splashing effect as the sealhead 168 moves through the bath oil. The combination of the tapered leading portion 182 with the concave neck 180 and base portion 178 create a stepped profile that influences oil displacement and distribution patterns within the suspension fork 100.

In this embodiment, the machined features 194 are smaller or less pronounced compared to those shown in FIG. 8. The machined features 194 can be positioned at a portion of the leading portion 182 most proximal to the neck 180. This positioning may still permit interfacing with a wrench, socket, or like too, while allowing for more nuanced interactions with the oil flow, directing oil in specific patterns that complement the overall geometry of the sealhead 168. The reduced prominence of the machined features 194 may thus result in more subtle fluid directing characteristics, which can be beneficial in certain riding conditions or fork configurations.

The bottom surface 189 of the sealhead 168 may remain relatively flat or planar, similar to previous embodiments, to facilitate splashing. The transition points between the base portion 178, neck 180, and leading portion 182 may be smoothly blended due to the concave and tapered profiles, further refining oil flow characteristics and reducing stress concentrations in the sealhead 168.

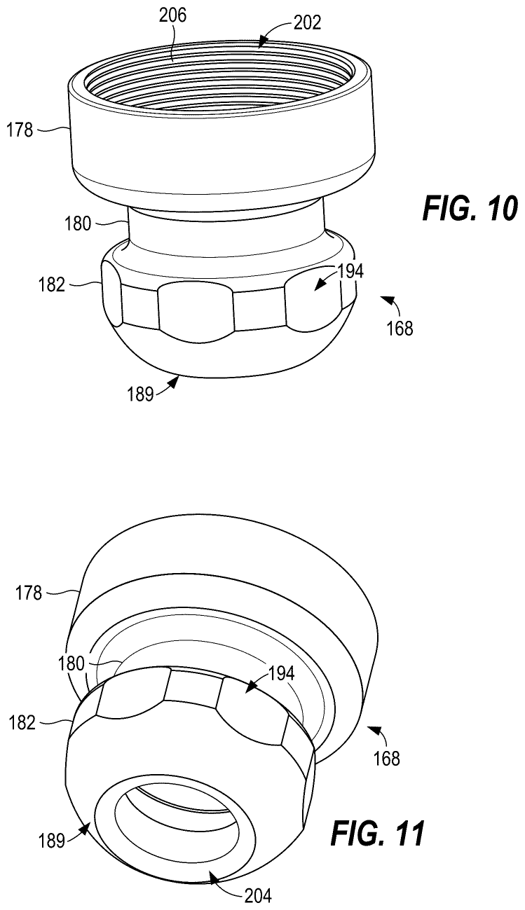

Turning now to FIGS. 10 and 11, FIG. 10 is an upper perspective view of the sealhead 168 and FIG. 11 is a lower perspective view of the sealhead 168. Referring to FIGS. 10 and 11 collectively, the sealhead 168 includes an upper aperture 202 and lower aperture 204 that are in communication with one another. The upper aperture 202 shows internal threads 206 for coupling the sealhead 168 to the threads 169 of the cylinder 164.

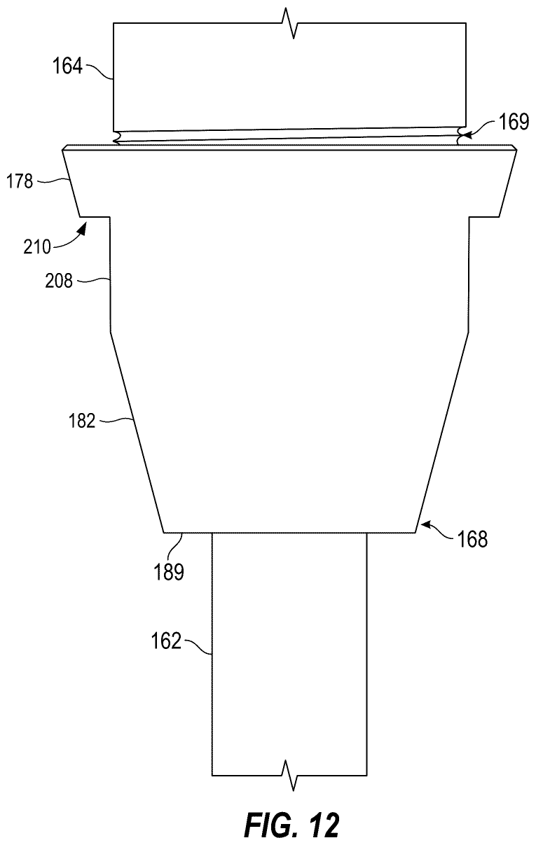

Referring to FIG. 12, another alternative embodiment of the sealhead 168 is shown. In this embodiment, the sealhead 168 has a base portion 178, a leading portion 182, and an intermediary portion 208 positioned between the base portion 178 and the leading portion 182. The base portion 178 has a diameter greater than both the leading portion 182 and the intermediary portion 208, with edges that taper downwards from the base portion 178 toward the intermediary portion 208. A difference in the outer diameter of the base portion 178 and the intermediate portion 208 create a lip 210 in the base portion 178 that extends from the intermediary portion 208.

The intermediary portion 208 has a uniform outer diameter that remains constant along its length, creating a cylindrical section between the tapered base portion 178 and the tapered leading portion 182. Thus, the intermediary portion 208 may provide a stable region for mounting seals, bushings, or other components while maintaining consistent clearances with surrounding structures. Moreover, the intermediary portion 208 may serve as a transitional area that influences oil flow patterns as the sealhead 168 moves through the bath oil during compression and rebound cycles.

The leading portion 182 tapers downwards from the intermediary portion 208 without creating any steps or lips, narrowing toward the bottom of the sealhead 168, which may enhance the hydrodynamic characteristics of the sealhead 168, contributing to the splashing effect as it moves through the bath oil. The combination of the tapered base portion 178, uniform intermediary portion 208, and tapered leading portion 182 creates a tapered and stepped profile that optimizes oil displacement and distribution patterns within the suspension fork 100.

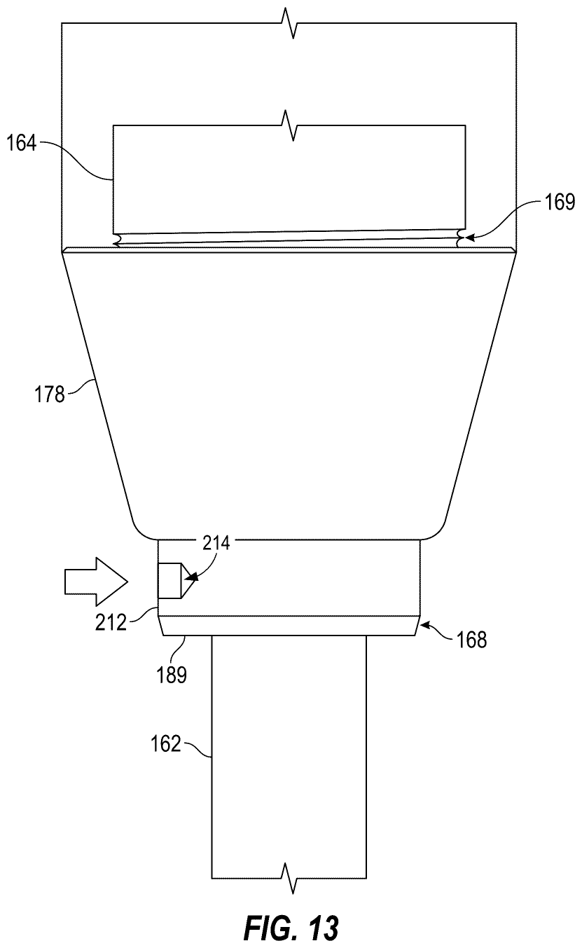

Referring to FIG. 13, yet another alternative embodiment of the sealhead 168 is shown. In this embodiment, the sealhead 168 includes the base portion 178 which tapers downwards to create a generally triangular section having no ridges or lips. To this end, the base portion 178 extends to a cylindrical collar portion 212 of the sealhead 168. The collar portion 212 does not have a tapered diameter, and instead has a uniform diameter. The collar portion 212 can include pin apertures 214 configured to receive pin projections from a pin tool, which may facilitate installation of the sealhead 168 onto the threads 169 of the cylinder 164.

The triangular profile of the base portion 178 may provide a streamlined transition from the cylinder 164 to the collar portion 212, reducing flow resistance as the sealhead 168 moves through the bath oil 174. The uniform diameter of the collar portion 212 may offer a consistent interface for tooling while maintaining structural integrity during installation and removal procedures.

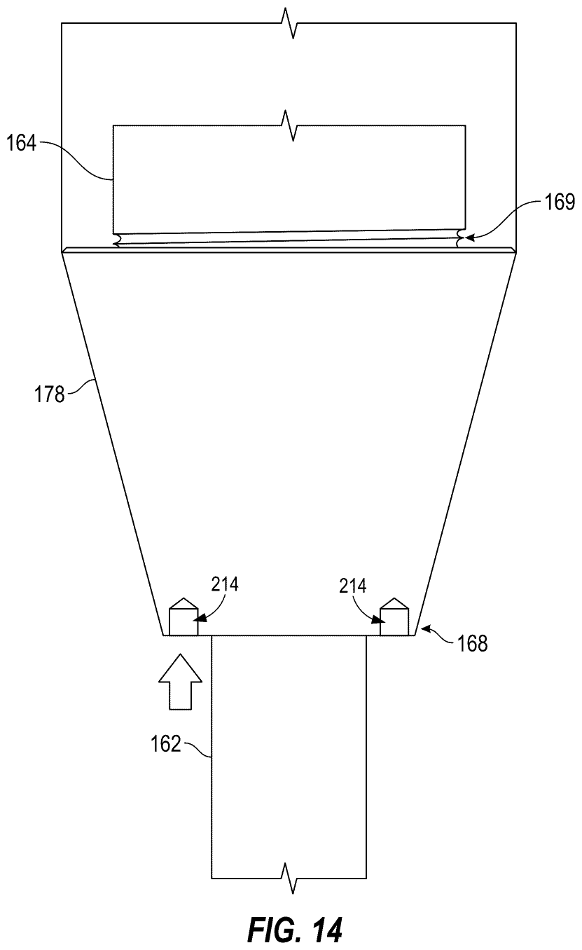

In some embodiments, pin apertures 214 are positioned on opposing sides of the collar portion 212. The pin apertures 214 in the collar portion 212 may be positioned diametrically opposite to one another, allowing for balanced application of torque during installation. While shown as being positioned in the side walls in FIG. 13, in FIG. 14, the pin apertures 214 can be positioned along the bottom surface. In some embodiments, the pin apertures 214 may be sized to accommodate standard pin tool configurations, providing compatibility with commonly available installation tools.

FIG. 14 shows another embodiment of the sealhead 168, where the base portion 178 tapers downwards to create a generally triangular section having no ridges or lips. Thus, a top portion of the base portion 178 has a diameter greater than a bottom portion of the base portion 178. However, there is no collar portion 212 present in the embodiment of FIG. 14 and, as such, there is a pronounced ridge defined by a bottom surface of the base portion 178 as it transitions to the rebound damper shaft 162. While the embodiment of FIG. 13 shows pin apertures 214 positioned in the side walls of the base portion 178, in FIG. 14, the pin apertures 214 are positioned along the bottom surface, permitting a connection with a pin tool for threadably coupling the base portion 178 to the cylinder 164 or other components.

The sealhead 168 may be constructed from various materials selected to provide optimal performance characteristics for the suspension fork 100, especially in bicycle settings. In some embodiments, the sealhead 168 may be formed of aluminum, which can be lightweight and offer corrosion resistance and machinability. In other embodiments, the sealhead 168 may be constructed from stainless steel which may be slightly heavier than aluminum, but may offer strength and resistance to corrosion from bath oil 174 and environmental exposure. Additional materials that may be employed for the sealhead 168 include metal and titanium alloys, which can provide a balance of low weight and high strength. The choice of material for the sealhead 168 may be selected based on factors such as weight requirements, operating environment, manufacturing considerations, and desired performance characteristics of the suspension fork 100.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A suspension fork, comprising:
a fork leg comprising an upper tube and a lower tube slidably engaged with one another for compression and rebound;
a damper assembly positioned within the fork leg, the damper assembly comprising a shaft and a sealhead coupled to the shaft; and
a reservoir configured to retain bath oil in proximity to the sealhead, wherein the sealhead is sized and positioned to splash the bath oil upwards when the sealhead is driven into the bath oil during the compression of the suspension fork.

2. The suspension fork according to claim 1, wherein the sealhead comprises a base portion and a leading portion tapering downwards.

3. The suspension fork according to claim 2, wherein the sealhead further comprises a neck having a diameter less than an adjacent portion of the leading portion, wherein the diameter of the neck is less than a diameter of the base portion.

4. The suspension fork according to claim 3, wherein the base portion is configured to form a connection with a cylinder positioned in the fork leg, and the shaft extends through the cylinder.

5. The suspension fork according to claim 3, wherein the sealhead comprises a bottom surface, wherein the bottom surface of the sealhead is flat.

6. The suspension fork according to claim 1, wherein the sealhead has a first annular recess having an annular bushing positioned therein, and a second annular recess having an annular seal positioned therein.

7. The suspension fork according to claim 1, wherein the fork leg comprises an upper tube, at least one bushing, and a foam ring, at least one of the upper tube, the at least one bushing, and the foam ring having an amount of the bath oil coated thereon in response to a splashing of the bath oil by the sealhead.

8. The suspension fork according to claim 1, wherein the sealhead has a base portion, a leading portion, and an intermediary portion positioned between the base portion and the leading portion, the base portion having a diameter greater than the leading portion and the intermediary portion and having edges that taper downwards, the intermediary portion having a uniform outer diameter, and the leading portion tapering downwards from the intermediary portion.

9. The suspension fork according to claim 3, wherein the base portion tapers downwards to the neck, and the leading portion tapers downwards from the neck.

10. The suspension fork according to claim 9, wherein at least one of the leading portion, the neck, or the base portion has a concave surface.

11. The suspension fork according to claim 2, further comprising a plurality of first machined features positioned in an annular arrangement around a topmost edge of the leading portion for tightening the sealhead to a damper tube cylinder, and at least one second machined feature that facilitates a splashing or navigation of the bath oil relative to the sealhead.

12. A suspension fork, comprising:
an upper tube;
a lower tube slidably engaged with the upper tube;
a damper assembly positioned within at least one of the upper tube or the lower tube, the damper assembly comprising a shaft and a sealhead coupled to the shaft, the sealhead configured to translate relative to the lower tube; and
a reservoir configured to retain bath oil, wherein the sealhead comprises: a base portion and a leading portion tapering downwards from the base portion, wherein the sealhead is configured to splash the bath oil upwards when driven into the bath oil during compression of the suspension fork.

13. The suspension fork according to claim 12, wherein the sealhead further comprises a neck positioned between the base portion and the leading portion, wherein the neck has a diameter less than an adjacent portion of the leading portion.

14. The suspension fork according to claim 12, wherein the base portion has a U-shaped cross-section and is configured to form a connection with a cylinder positioned in at least one of the upper tube or the lower tube.

15. The suspension fork according to claim 12, wherein the sealhead comprises a first annular recess having an annular bushing positioned therein, and a second annular recess having an annular seal positioned therein.

16. The suspension fork according to claim 12, wherein the fork leg comprises an upper tube, at least one bushing, and a foam ring, at least one of the upper tube, the at least one bushing, and the foam ring having an amount of the bath oil coated thereon in response to a splashing of the bath oil by the sealhead.

17. The suspension fork according to claim 13, wherein the base portion tapers downwards to the neck.

18. The suspension fork according to claim 12, wherein the sealhead has a base portion, a leading portion, and an intermediary portion positioned between the base portion and the leading portion, the base portion having a diameter greater than the leading portion and the intermediary portion and having edges that taper downwards, the intermediary portion having a uniform outer diameter, and the leading portion tapering downwards from the intermediary portion.

19. A method, comprising:
providing a suspension fork, the suspension fork comprising a fork leg, the fork leg comprising a shaft and a sealhead coupled to the shaft, and a reservoir retaining bath oil in proximity to the sealhead; and
during a compression of the fork leg, causing, by the sealhead, the bath oil to splash upwards to lubricate an upper component of the fork leg.

20. The method according to claim 19, wherein the upper component as lubricated comprises at least one of: an upper tube of the fork leg; at least one upper bushing; and a foam ring.
